(19) United States
(12) Patent Application Publication
(10) Pub. No.: US 2018/0111257 A1
(43) Pub. Date: Apr. 26, 2018

(54) ELECTRIC CHISEL CAPABLE OF BEING MATCHED WITH DOMESTIC ELECTRIC DRILL TO BE USED

(71) Applicants: BRENT GORDON MC ARTHUR, Blue Springs, MO (US); WILLIAM KEVIN BREWSTER, Blue Springs, MO (US); Xiaoyuan Ma, Shenzhen (CN)

(72) Inventors: BRENT GORDON MC ARTHUR, Blue Springs, MO (US); WILLIAM KEVIN BREWSTER, Blue Springs, MO (US); Xiaoyuan Ma, Shenzhen (CN)

(21) Appl. No.: 15/339,935

(22) Filed: Nov. 1, 2016

(30) Foreign Application Priority Data
Oct. 20, 2016 (CN) 201621140633.3

(51) Int. Cl. B25D 11/10; B25F 3/00; B25D 17/02

(52) U.S. Cl. CPC B25D 11/102; B25F 3/00; B25D 2217/0096; B25D 2211/064; B25D 17/02

(57) ABSTRACT

The present invention discloses an electric chisel capable of being matched with a domestic electric drill to be used. The electric chisel comprises an electric drill, a casing, a push rod and chisel head mechanism and a groove cam mechanism. The top of the casing is provided with an oil hole, and a rubber plug is arranged on the oil hole to be used for preventing dust; the two ends of the groove cam mechanism are provided with a first bearing and a second bearing respectively, and a first groove and a second groove are formed below the first bearing and the second bearing respectively and positioned in the inner wall of the casing. The groove cam mechanism is provided with a groove, and the push rod and chisel head mechanism is connected with the groove cam mechanism and performs reciprocating motion up and down in the groove of the groove cam mechanism. During the use, the whole electric chisel is installed on the domestic electric drill, and when the groove cam mechanism is driven by the electric drill to rotate, the push rod and chisel head mechanism performs liner reciprocating motion. The electric chisel is simple in structure, small in size, portable and convenient to operate and can quickly chisel floors or wall tiles.

### CROSS-REFERENCE TO RELATED APPLICATIONS

This application claims priority benefit of Chinese Patent Application No. 201621140633.3 with a filing date of Oct. 20, 2016. The content of the aforementioned application, including any intervening amendments thereto, are incorporated herein by reference.

### TECHNICAL FIELD

The present invention relates to the technical field of tools, and in particular to an electric chisel capable of being matched with a domestic electric drill to be used.

### BACKGROUND OF THE PRESENT INVENTION

Currently, the real estate industry is being developed rapidly. In interior decoration of houses, plenty of labor is needed, which increases house costs invisibly; during building decoration design, replacement with new tiles and floors needs to be performed on old building walls, the dismantling work is still done by manpower, and old tiles and floors are removed little by little manually through a hammer and a chisel. This operation mode has the shortcomings of much occupied labor, low degree of mechanization, long construction period, much dust and severe environmental pollution and the like. Therefore, it is very important to design an electric dismantling tool to replace manpower.

### SUMMARY OF PRESENT INVENTION

An objective of the present invention is to provide an electric chisel which is simple in structure, small in size, portable and convenient to operate, can quickly chisel floors or wall tiles and can be matched with a domestic electric drill to be used, so as to solve the problems in the background art.

In order to implement the objective, the present invention provides the following technical solution: the electric chisel capable of being matched with the domestic electric drill to be used comprises an electric drill, a casing, a push rod and chisel head mechanism and a groove cam mechanism; the top of the casing is provided with a second oil hole which is provided with a second rubber plug; the two ends of the groove cam mechanism are provided with a first bearing and a second bearing respectively, and a first groove and a second groove are formed below the first bearing and the second bearing respectively and formed in the inner wall of the casing; the middle part of the groove cam mechanism is provided with a groove, and one end of the push rod and chisel head mechanism is connected with the groove cam mechanism and performs reciprocating motion up and down in the groove of the groove cam mechanism; and the lower portion of the casing is provided with a first oil hole which is provided with a first rubber plug.

As a preferred solution, the inner wall of the casing is further provided with a guide groove, the right end of the guide groove is provided with a guide sleeve, and a push rod of the push rod and chisel head mechanism is placed in the guide groove and limited and supported through the guide groove and the guide sleeve.

As a preferred solution, the push rod and chisel head mechanism forms a right angle and is connected with the groove cam mechanism and the guide sleeve.

As a preferred solution, the groove cam mechanism and the push rod and chisel head mechanism are formed by a firm steel material.

As a preferred solution, the push rod and chisel head mechanism is formed by the push rod and a chisel head which are of an integrated structure.

As a preferred solution, the cross sections of both the first rubber plug and the second rubber plug are trapezoidal.

As a preferred solution, the first bearing is installed in the first groove, and the second bearing is installed in the second groove.

Compared with the prior art, the electric chisel capable of being matched with domestic electric drill to be used has the beneficial effects that:

(1) the electric chisel is simple in structure, small in size, portable and convenient to operate and can quickly chisel floors or wall tiles; and

(2) the electric chisel greatly reduces decoration cost and manpower and is convenient to popularize.

### DESCRIPTION OF THE DRAWINGS

FIG. 1 is a schematic structural diagram of the present invention; and

FIG. 2 is a schematic structural diagram of a planed face of the present invention.

In the figures, there is a casing 1, a guide groove 2, a first bearing 3, a groove cam mechanism, a first groove 5, a guide sleeve 6, a push rod and chisel head mechanism 7, a second bearing 8, a second groove 9, a first oil hole 10, a first rubber plug 11, a second oil hole 12, a second rubber plug 13 and an electric drill 14.

### DETAILED DESCRIPTION OF PREFERRED EMBODIMENTS

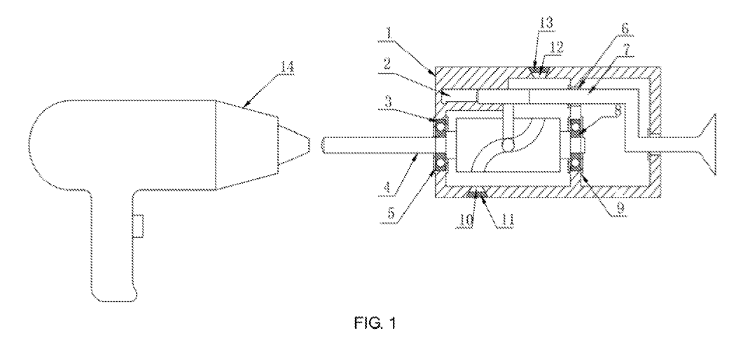

Referring to FIG. 1, the present invention provides the technical solution: an electric chisel capable of being matched with a domestic electric drill to be used comprises an electric drill 14, a casing 1, a push rod and chisel head mechanism 7 and a groove cam mechanism 4; the top of the casing 1 is provided with a second oil hole 12, and a second rubber plug 13 is arranged on the second oil hole 12 to be used for preventing dust; the groove cam mechanism 4 is arranged in the casing 1; the two ends of the groove cam mechanism 4 are provided with a first bearing 3 and a second bearing 8 respectively, and a first groove 5 and a second groove 9 are formed in the inner wall of the casing 1. The groove cam mechanism 4 is limited and supported through the two bearings 3 and 8 which are installed in the two grooves 5 and 9 of the casing respectively; the middle part of the groove cam mechanism 4 is provided with a groove, and one end of the push rod and chisel head mechanism 7 is connected with the groove cam mechanism 4 and performs reciprocating motion up and down in the groove of the groove cam mechanism 4; and the lower portion of the casing is provided with a first oil hole 10 which is provided with a first rubber plug 11. The cross sections of both the first rubber plug and the second rubber plug are trapezoidal, and lubricating oil can be added into the groove to reduce friction.

The inner wall of the casing 1 is further provided with a guide groove 2, the right end of the guide groove 2 is provided with a guide sleeve 6, and a push rod of the push rod and chisel head mechanism 7 is placed in the guide groove 2 and limited and supported through the guide groove 2 and the guide sleeve 6.

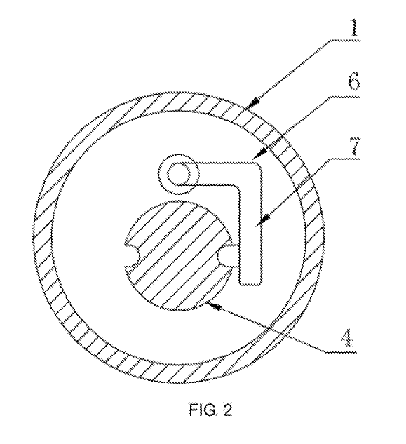

Referring to FIG. 2, the push rod and chisel head mechanism 7 is formed by the push rod and a chisel head which are of an integrated structure. Moreover, the push rod and chisel head mechanism 7 forms a right angle and is connected with the groove cam mechanism 4 and the guide sleeve 6. The groove cam mechanism 4 and the push rod and chisel head mechanism 7 are formed by a firm steel material.

During use, a port at the left end of the whole electric chisel is installed on the domestic electric drill. When the groove cam mechanism 4 is driven by the electric drill 14 to rotate, the push rod and chisel head mechanism 7 performs liner reciprocating motion in the groove of the groove cam mechanism 4, and driving force of the electric drill 14 enables the chisel head of the push rod and chisel head mechanism 7 to be embedded in and chisel floors or wall tiles needing to be removed. The electric chisel capable of being matched with the domestic electric drill to be used is simple in structure, small in size, portable and convenient to operate and can quickly chisel floors or wall tiles.

We claim:

1. An electric chisel capable of being matched with a domestic electric drill to be used, comprising an electric drill (14), a casing (1), a push rod and chisel head mechanism (7) and a groove cam mechanism (4), wherein the top of the casing (1) is provided with a second oil hole (12) which is provided with a second rubber plug (13); the two ends of the groove cam mechanism (4) are provided with a first bearing (3) and a second bearing (8) respectively, and a first groove (5) and a second groove (9) are formed below the first bearing (3) and the second bearing (8) respectively and positioned in the inner wall of the casing (1); the middle part of the groove cam mechanism (4) is provided with a groove, and one and of the push rod and chisel head mechanism (7) is connected with the groove cam mechanism (4) and performs reciprocating motion up and down in the groove of the groove cam mechanism (4); and the lower portion of the casing (1) is provided with a first oil hole (10) which is provided with a first rubber plug (11).

2. The electric chisel capable of being matched with the domestic electric drill to be used according to claim 1, wherein the inner wall of the casing (1) is further provided with a guide groove (2), the right end of the guide groove is provided with a guide sleeve (6), and a push rod of the push rod and chisel head mechanism (7) is placed in the guide groove (2) and limited and supported through the guide groove (2) and the guide sleeve (6).

3. The electric chisel capable of being matched with the domestic electric drill to be used according to claim 1, wherein the push rod and chisel head mechanism (7) forms a right angle and is connected with the groove cam mechanism (4) and the guide sleeve (6).

4. The electric chisel capable of being matched with the domestic electric drill to be used according to claim 1, wherein the groove cam mechanism (4) and the push rod and chisel head mechanism (7) are formed by a firm steel material.

5. The electric chisel capable of being matched with the domestic electric drill to be used according to claim 2, wherein the push rod and chisel head mechanism (7) is formed by the push rod and a chisel head which are of an integrated structure.

6. The electric chisel capable of being matched with the domestic electric drill to be used according to claim 1, wherein the cross sections of both the first rubber plug (11) and the second rubber plug (13) are trapezoidal.

7. The electric chisel capable of being matched with the domestic electric drill to be used according to claim 1, wherein the first bearing (3) is installed in the first groove (5), and the second bearing (8) is installed in the second groove (9).
